(19) United States
(12) Patent Application Publication
(10) Pub. No.: US 2010/0006321 A1
(43) Pub. Date: Jan. 14, 2010

(54) VIDEO/AUDIO SIGNAL TRANSMISSION CABLE

(75) Inventor: Te-Li HUANG, Jhonghe City (TW)

Correspondence Address: YOUNG & THOMPSON, 209 Madison Street, Suite 500, Alexandria, VA, 22314, US

(73) Assignee: COPARTNER TECHNOLOGY CORP, Jhonghe City (TW)

(21) Appl. No.: 12/499,286

(22) Filed: Jul. 8, 2009

(30) Foreign Application Priority Data
Jul. 8, 2008 (TW) 097125784

(51) Int. Cl. H01B 11/02

(52) U.S. Cl. 174/117 R

(57) ABSTRACT

The present invention disclose a video/audio signal transmission cable comprising a first and a second conducting wires respectively having conductor and insulator, and the first and second conducting wires are neighborly installed, wherein each conductor has a core being made of steel material and being electroplated with a high conductive metal plating layer on the outside surface thereof; a first enclosing layer being made of insulation material is used to enclose the outsides of the first and second conducting wires; and a second enclosing layer being made of insulation material is used to enclose the outside of the first enclosing layer. It is then through the material characteristics of the core and high conducting metal plating layer to have the signal equalization effect during high frequency and low frequency transmissions thereby achieving the better quality and stable transmission effect.

### FIELD OF THE INVENTION

The invention is related to a video/audio signal transmission cable, which having signal equalization effect in high frequency arid low frequency transmission thereby achieving better quality and stable transmission effect.

### BACKGROUND OF THE INVENTION

For conventional video/audio high frequency signal transmission (as shown in FIG. 3), the transmission cable comprises two parallel arranged or twisted conducting wires 8, 9, wherein each conducting wire 8, 9 is respectively constituted by a central conductor 81, 91 being respectively enclosed by the insulators 82, 92 external to the central conductor thereby achieving the video/audio high frequency signal transmission effect through the central conductor 81, 91 of each conducting wire 8, 9.

Notwithstanding that the central conductor 81, 89 of each conducting wire 8, 9 as described above can be utilized for video/audio high frequency signal transmission, as the central conductor 81, 91 of each conducting wire 8, 9 is generally made of metal with electroplated copper or bare copper material and conductivity ratio of central conductors 81, 91 shall be near to 100% theoretically; therefore, even though better transmission effect can be obtained by the interior of the central conductors 81, 91 in low frequency signal transmission, the high frequency signal being transmitted on the surface of central conductors 81, 91 is unable to achieve the equalization effect due to limitation of their material characteristics in the skin effect, and as a consequence, the high quality transmission for high frequency signals is therefore unable to obtain.

### SUMMARY OF THE INVENTION

Therefore, the main purpose of the present invention is through the material characteristics of the core and high conducting metal plating layer to have the signal equalization effect during high frequency and low frequency transmissions thereby achieving the better quality and stable transmission effect.

To achieve aforesaid purpose, the present invention disclose a video/audio signal transmission cable comprising a first conducting wire having conductor and insulator, wherein the conductor has a core being made of steel material and being electroplated with a high conductive metal plating layer on the outside surface thereof; a second conducting wire being installed at one side of the above said first conductor at least comprises a conductor being enclosed by the insulator on the outside thereof, wherein the conductor has a core being made of steel material and being electroplated with a high conductive metal plating layer on the outside surface thereof; a first enclosing layer being made of insulation material is used to enclose the outsides of the first and second conducting wires; and a second enclosing layer being made of insulation material is used to enclose the outside of the first enclosing layer.

### BRIEF DESCRIPTION OF THE DRAWINGS

FIG. 1 is a sectional schematic view of the present invention

FIG. 2 is a schematic view showing the usage status of the present invention

FIG. 3 is a sectional schematic view of conventional construction.

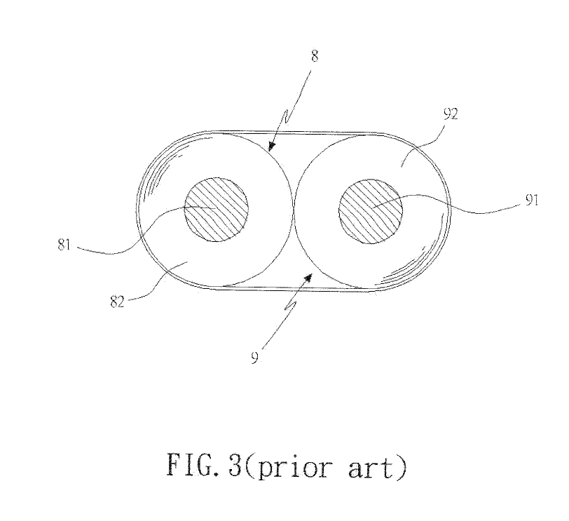

### DETAIL DESCRIPTION OF THE PREFERRED EMBODIMENTS

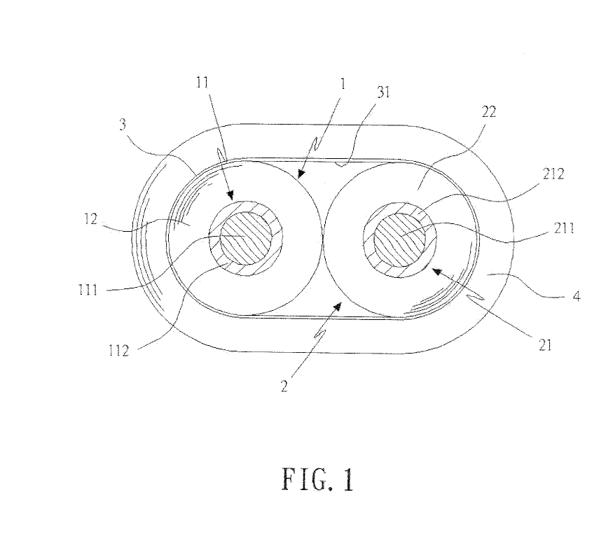

FIG. 1 is a sectional schematic view of the present invention. As shown in the figure, the video/audio signal transmission cable of the present invention is constituted by at least a first conducting wire 1, a second conducting wire 2, a first enclosing layer 3 and a second enclosing layer 4.

Said first conducting wire 1 at least comprises a conductor 11 being enclosed by the insulator 12 on the outside thereof, wherein the conductor 11 has a core 111 being made of steel material and being electroplated with a high conductive metal plating layer 112 on the outside thereof, while the high conductive metal plating layer 112 is made of copper, silver or the material being first electroplated with copper and then electroplated with silver, and the conductivity ratio of the conductor 11 is smaller than 20%.

Said second conducting wire 2 being installed at one side of the above said first conducting wire 1 at least comprises a conductor 21 being enclosed by the insulator 22 on the outside thereof, wherein the conductor 21 has a core 211 being made of steel material and being electroplated with a high conductive metal plating layer 212 on the outside thereof, while the high conductive metal plating layer 212 is made of copper, silver or the material being first electroplated with copper and then electroplated with silver, and the conductivity ratio of the conductor 21 is smaller than 20%.

The first enclosing layer 3 being made of insulation material is used to enclose the outsides of the first and second conducting wires 1, 2, wherein the first enclosing layer 3 is a thermo-melting polyester tape having a thermo-melting surface 31 corresponding to the first and second conducting wires 1, 2.

The second enclosing layer 4 being made of insulation material is used to enclose the outside of the first enclosing layer 3 thereby constituting the brand new video/audio signal transmission cable.

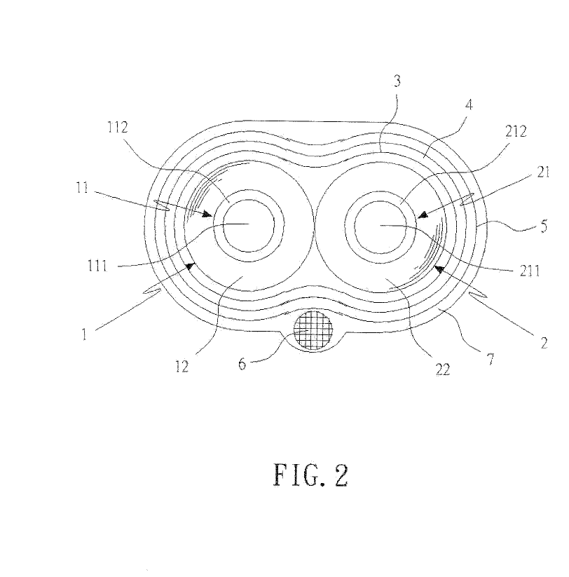

FIG. 2 is a schematic view showing the usage status of the present invention. As shown by the figure, the second enclosing layer 4 is enclosed by a shielding layer 5 on the outside thereof, a grounding wire 6 is made on top of shielding layer 5 between first and second conducting wires 1, 2, and shielding layer 5 and grounding wire 6 are further enclosed by a third enclosing layer 7 at the outside thereof, wherein shielding layer 5 can be an aluminum mylar tape having its conducting side to contact with grounding wire 6.

When the transmission cable of the present invention is used for high frequency video/audio signal transmission, it is done by utilizing the material characteristics of cores 111, 211 of conductors 11, 21 and high conductive metal plating layers 112, 212 being installed by the first and second conducting wires 1, 2, wherein cores 111, 211 are used for audio signal (low frequency) transmission, while high conductive metal plating layers 112, 212 are used for video signals (high frequency) transmission, and therefore the video/audio signal transmission cable is through incorporating said material characteristics to have the signal equalization effect during high frequency and low frequency transmissions thereby achieving the better quality and stable transmission effect.

As summarized from above descriptions, the video/audio signal transmission cable of the present invention is through the material characteristics of the core and high conducting metal plating layer to have the signal equalization effect during high frequency and low frequency transmissions thereby achieving the better quality and stable transmission effect and make the present invention more progressive, more practical and more conforming to user requirement thus meeting the condition of patent application, therefore it is applied herein according to the law.

As the above descriptions are only for the preferred embodiments of the present invention, they shall not be used to limit the scope of the present invention; therefore, all simply equivalent changes and modifications based on claims and contents of the specification of invent ion shall still belong to the scope of the invention.

What is claimed is:

1. A video/audio signal transmission cable comprises:
A first conducting wire at least comprises a conductor being enclosed by the insulator on the outside thereof, wherein the conductor has a core being made of steel material and being electroplated with a high conductive metal plating layer on the outside surface thereof;
A second conducting wire being installed at one side of the above said first conductor at least comprises a conductor being enclosed by the insulator on the outside thereof, wherein the conductor has a core being made of steel material and being electroplated with a high conductive metal plating layer on the outside surface thereof;
A first enclosing layer being made of insulation material is used to enclose the outsides of the first and second conducting wires; and
A second enclosing layer being made of insulation material is used to enclose the outside of the first enclosing layer.

2. The video/audio signal transmission cable as claimed in claim 1, wherein conductivity ratios of the conductors of the first and second conducting wires are all smaller than 20%.

3. The video/audio signal transmission cable as claimed in claim 1, wherein the high conductive metal plating layers of the first and second conducting wires are made of copper.

4. The video/audio signal transmission cable as claimed in claim 1, wherein the high conductive metal plating layers of the first and second conducting wires are made of silver.

5. The video/audio signal transmission cable as claimed in claim 1, wherein the high conductive metal plating layers of the first and second conducting wires are made of the material being first electroplated with copper and then electroplated with silver.

6. The video/audio signal transmission cable as claimed in claim 1, wherein the first enclosing layer is a thermo-melting polyester tape having a thermo-melting surface corresponding to the first and second conducting wires.

7. The video/audio signal transmission cable as claimed in claim 1, wherein the second enclosing layer is enclosed by a shielding layer on the outside thereof, a grounding wire is made on top of shielding layer between first and second conducting wires, and shielding layer a grounding wire are further enclosed by a third enclosing layer at the outside thereof.

8. The video/audio signal transmission cable as claimed in claim 7, wherein the shielding layer can be an aluminum foil having its conductive side to contact with the grounding wire.
